(19) United States
(12) Patent Application Publication
(10) Pub. No.: US 2024/0087084 A1
(43) Pub. Date: Mar. 14, 2024

(54) SYSTEMS AND METHODS FOR PRODUCING ISOTROPIC IN-PLANE SUPER-RESOLUTION IMAGES FROM LINE-SCANNING CONFOCAL MICROSCOPY

(71) Applicants: THE USA, as represented by the Secretary, Department of Health and Human Services, Bethesda, MD (US); THE UNIVERSITY OF CHICAGO, Chicago, IL (US)

(72) Inventors: Hari SHROFF, Bethesda, MD (US); Yicong WU, Bethesda, MD (US); Xiaofei HAN, Bethesda, MD (US); Patrick LA RIVIERE, Chicago, IL (US)

(21) Appl. No.: 18/271,202

(22) PCT Filed: Jan. 6, 2022
(86) PCT No.: PCT/US2022/011484

§ 371 Date: Jul. 6, 2023

Related U.S. Application Data
(60) Provisional application No. 63/134,907, filed on Jan. 7, 2021.

(51) Int. Cl. G06T 3/40; G06T 5/50

(52) U.S. Cl. CPC G06T 3/4053; G06T 3/4046; G06T 5/50; G06T 2207/10056; G06T 2207/20212

(57) ABSTRACT

Various embodiments for systems and methods for producing one-dimensional super-resolved images from diffraction-limited line-confocal images using a trained neral network to generate a one-dimensional super-resolved output as well as an isotropic, in-plane super-resolved image are disclosed, wherein the neural network is trained using a training set comprising a plurality of matched training pairs, each training pair of the plurality of training pairs comprising a diffraction-limited line confocal image of the plurality of diffraction-limited line confocal images of the image type and a one dimensional super resolved image corresponding to the diffraction-limited line confocal image of the plurality of diffraction limited line confocal images.

### FIELD

The present disclosure generally relates to producing super-resolution images from diffraction-limited images; and in particular, to systems and methods for producing super-resolution images from diffraction-limited line-confocal images using a trained neural network to produce a one-dimensional super-resolved image output as well as an isotropic, in-plane super-resolved image obtained by combining one-dimensional super-resolved images at different orientations.

### BACKGROUND

Line confocal microscopy illuminates a fluorescently labeled sample with a sharp, diffraction-limited illumination that is focused in one spatial dimension. If the resulting fluorescence emitted by the sample is filtered through a slit and recorded as the illumination line is scanned across the sample, an optically-sectioned image with reduced contamination from out of focus fluorescence is obtained. While not commonly appreciated, the fact that the illumination of the sample is necessarily diffraction-limited implies that—if additional images are acquired, or optical reassignment techniques are used—spatial resolution can be improved in the direction in which the line is focused (i.e., along one spatial dimension). However, all such techniques for improving one-dimensional resolution in line confocal microscopy impart more dose or require more images than conventional, diffraction-limited confocal microscopy.

It is with these observations in mind, among others, that various aspects of the present disclosure were conceived and developed.

### BRIEF DESCRIPTION OF THE DRAWINGS

FIG. 1 is a schematic showing an embodiment of a line-scanning confocal microscopy system for generating sharp line illumination of a sample for obtaining diffraction-limited line-confocal images and matched phase shifted phi₁, phi₂, and phi₃ images.

FIG. 2A is an illustration of a line-scanned confocal image when a diffraction-limited illumination line is scanned horizontally from left to right of the line-confocal image using the microscopy system of FIG. 1; FIG. 2B is an illustration showing sparse periodic illumination patterns that result when the diffraction-limited illumination line scans are blanked at specific intervals and then phase shifted by about 120 degrees relative to each other to produce matched phase shifted phi₁, phi₂, and phi₃ images; and FIG. 2C is an illustration showing a laterally super-resolved image that combines the sparse periodic illumination patterns for each phase shifted phi 1, phi2, and phi3 images shown in FIG. 2B.

FIG. 3 is a simplified illustration that shows a training set of matched data training pairs with each having a diffraction-limited line-confocal image (left) of a cell and a corresponding one-dimensional super-resolved image (right) of the same cell used to train a neural network to produce a one-dimensional super-resolved image based solely on evaluating a diffraction-limited line-confocal image input and predicting and then generating a one-dimensional super-resolved image of that evaluated diffraction-limited line-confocal image.

FIG. 4 is a simplified illustration that shows the manner in which the training sets of FIG. 3 are used to train the neural network to produce highly accurate predictions for generating a one-dimensional super-resolved image based on a diffraction-limited line-confocal image input.

FIG. 5A is an input image blurred with a two-dimensional diffraction-limited point spread function (PSF) using simulated test data; FIG. 5B is a deep learning output of a neural network after being trained using the simulated test data; and FIG. 5C is a one-dimensional super-resolved ground-truth image of the input image used to compare with the generated one-dimensional super-resolved image output of the trained neural network.

FIG. 6A is a simplified illustration showing a diffraction-limited image of a cell being rotated at different orientations (0 degrees, 45 degrees, 90 degrees, and 135 degrees) with each diffraction-limited image input to a trained neural network with the resultant images each having resolution enhanced in the horizontal direction; and FIG. 6B is a simplified illustration showing the output images from the trained neural network of FIG. 6A rotated back to the frame of the original image and combined using joint deconvolution.

FIG. 7A is a raw image simulated with a mixture of dots, lines, rings and solid circles, blurred with a diffraction-limited PSF and with Poisson and Gaussian noise added to the raw image; FIG. 7B are four images with one-dimensional super-resolution oriented along 0 degrees, 45 degrees, 90 degrees, and 135 degrees, respectively, after performing the steps shown in FIGS. 6A and 6B; and FIG. 7C is a super-resolved image with isotropic resolution in two dimensions after jointly deconvolving the four images in FIG. 7B.

FIG. 8 is an illustration with the top row showing the illumination patterns at phi₁, phi₂ and phi₃, the middle row showing images of real cells with microtubule markers and matched phi₁, phi₂, and phi₃ images, and the last row shows a diffraction-limited line-confocal image (left) and the super-resolved image (right) obtaining during testing.

FIG. 9A is a microtubule fluorescence image taken in diffraction-limited mode; FIG. 9B is a microtubule fluorescence image produced by the trained neural network; and FIG. 9C is a microtubule fluorescence image of the ground truth when local contraction is applied along the scanning direction, producing a super-resolution image with resolution enhanced along one (vertical) dimension.

FIG. 10A is the input showing a microtubule fluorescence image derived from the diffraction-limited data; FIG. 10B is the rotation and deep learning output showing microtubule fluorescence images along different axes of rotation; and FIG. 10C is a microtubule fluorescence image processed using joint deconvolution, which isotropizes the resolution gain.

Corresponding reference characters indicate corresponding elements among the view of the drawings. The headings used in the figures do not limit the scope of the claims.

### DETAILED DESCRIPTION

Various embodiments of systems and related methods for improving spatial resolution in line-scanning confocal microscopy using a trained neural network are disclosed herein. In one aspect, a method for improving spatial resolution includes generating a series of diffraction-limited line-confocal images of a sample or image-type by illuminating the sample or image-type with a plurality of sparse, phase-shifted diffraction-limited line illumination patterns produced by a line confocal microscopy system. Once these diffraction-limited line-confocal images are generated, a training set comprising a plurality of matched data training pairs is assembled in which each matched data training pair includes a diffraction-limited line-confocal image of a sample or image-type matched with a corresponding one-dimensional super-resolved image of that same diffraction-limited line-confocal image. The degree of resolution enhancement depends on how fine the fluorescence emission resulting from the line illumination is: for diffraction-limited illumination as in conventional line-scanning confocal microscopy, a theoretical resolution enhancement of ˜2-fold better than the diffraction limit may be achieved. However, if the fluorescence emission can be made to depend nonlinearly on the illumination intensity, e.g. using fluorescent dyes with a photoswitchable or saturable on or off state, there is in principle no limit to how fine the fluorescence emission can be. In this case, resolution enhancement more than two-fold (theoretically, ‘diffraction-unlimited’) is possible. In the simulated and experimental tests that were conducted thus far, a 2-fold resolution improvement over diffraction-limited resolution was achieved.

After the training set is so assembled, the matched data training pairs are used to train a neural network to “predict” and generate a one-dimensional super-resolved image output based solely on the evaluation of a diffraction-limited line-confocal image input which the neural network has not previously evaluated. The present system has successfully tested a residual channel attention network (ROAN) and U-net for such purposes, obtaining more than 2-fold resolution enhancement on diffraction-limited input. Taking the ROAN as an example: matched pairs of low-resolution and high-resolution images are input into the network architecture, and the network trained by minimizing the L1 loss between network prediction and ground truth super-resolved images. The ROAN architecture consists of multiple residual groups which themselves contain residual structure. Such ‘residual in residual’ structure forms a very deep network consisting of multiple residual groups with long skip connections. Each residual group also contains residual channel attention blocks (RCAB) with short skip connections. The long and short skip connections, as well as shortcuts within the residual blocks, allow low resolution information to be bypassed, facilitating the prediction of high resolution information. Additionally, a channel attention mechanism within the RCAB is used to adaptively rescale channel-wise features by considering interdependencies among channels, further improving the capability of the network to achieve higher resolution. The present system sets the number of residual groups (RG) to five; (2) in each RG, the RCAB number is set to three or five; (3) the number of convolutional layers in the shallow feature extraction is 32; (4) the convolutional layer in channel-downscaling has 4 filters, where the reduction ratio is set to 8; (5) all two-dimensional convolutional layers are replaced with three-dimensional convolutional layers; (6) the upscaling module at the end of the original ROAN is omitted because network input and output have the same size in the present system.

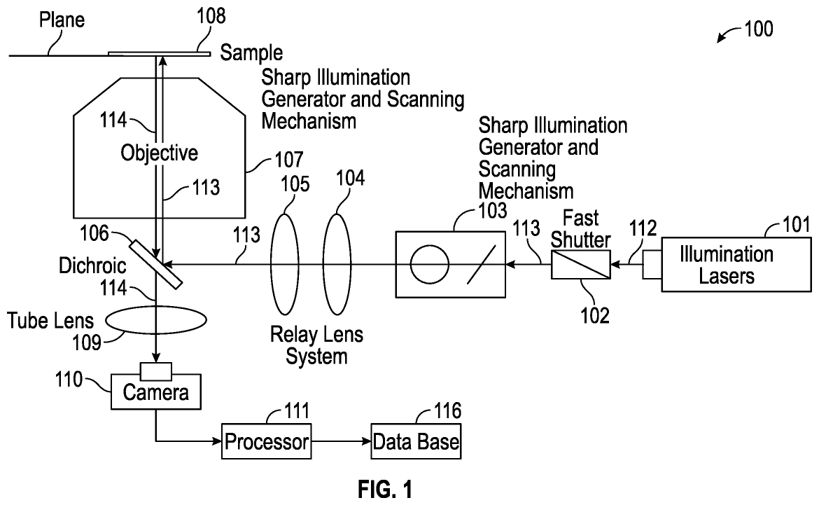

Once the neural network is trained with the matched data training pairs of a particular sample or image-type, the neural network acquires the ability to improve the spatial resolution of any diffraction-limited line-confocal image input of a similar sample or image-type by generating a one-dimensional super-resolved image output of the diffraction-limited line-confocal image input based solely on the training of the neural network using the plurality of matched data training pairs of a similar sample or image-type to generate the corresponding one-dimensional super-resolved image. In another aspect, the neural network may generate an isotropic in-plane super-resolved image by combining a plurality of images having one-dimensional spatial resolution improvement along different orientations. Referring to the drawings, systems and related methods for generating one-dimensional super-resolved images and isotropic, in-plane super-resolved images by a trained neural network are illustrated and generally indicated as 100, 200, 300 and 400 in FIGS. 1-10.

In one aspect, a neural network 302 is trained to predict and generate a one-dimensional super-resolved image 308 based solely on an evaluation of diffraction-limited line-confocal image 307 provided as input to the trained neural network 302A. Once evaluation of the diffraction-limited line-confocal image 307 is completed, the trained neural network 302A generates a one-dimensional super-resolved image 308 as output based on a prediction of how the diffraction-limited line-confocal image 307 would look like as a one-dimensional super-resolved image 308 without directly improving the spatial resolution of the diffraction-limited line-confocal image 307 itself by the trained neural network 302A. In particular, the trained neural network 302A is operable to generate a one-dimensional super-resolved image 308 by evaluating certain aspects and/or metrics of a particular sample or image-type in a diffraction-limited line-confocal image 307 provided as input to the trained neural network 302A which improves the spatial resolution of the diffraction-limited confocal image 307 to the level of a one-dimensional super-resolved image 306 as output without directly improving the spatial resolution of the diffraction-limited line-confocal image 307 that was evaluated. The trained neural network 302A is operable to enhance the spatial resolution of the diffraction-limited line-confocal image 307 being evaluated based on the previous training of the trained neural network 302A by having evaluated matched data training pairs 301 of diffraction-limited line-confocal image 304 and a corresponding one-dimensional super-resolved image 306.

During training of the neural network 302, the matched data training pairs 301, each consisting of a diffraction-limited line-confocal image 304 and a corresponding one-dimensional super-resolved image 306 based on that diffraction-limited line-confocal image 304 for a particular kind of sample or image-type, are used to train the neural network 302 to recognize similar aspects when later evaluating diffraction-limited line-confocal images 307 of similar samples or image-types as input 304 to the neural network 302. The trained neural network 302A is now operable to construct a one-dimensional super-resolved image 308 output based on the evaluated diffraction-limited line-confocal image input 307 to the trained neural network 302A. In addition, a method is disclosed herein that produces an isotropic, in-plane super-resolved image 310 by combining a series of one-dimensional super-resolved images 308A-D oriented along different axes relative to the plane of the sample or image-type by the trained neural network 302A as shall be discussed in greater detail below.

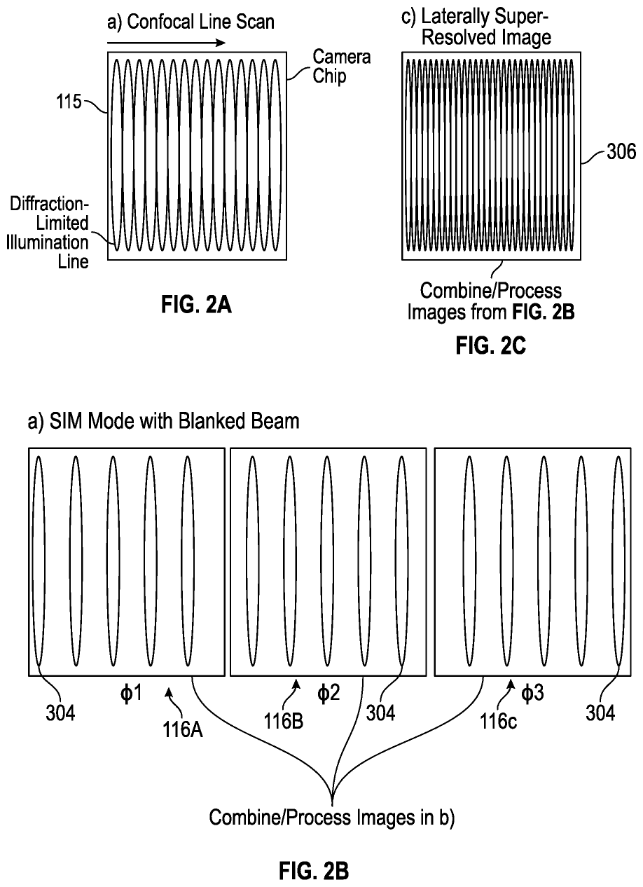

Referring to FIGS. 1 and 2A-2C, a plurality of diffraction-limited confocal images 304 may be generated using a line-scanning confocal microcopy system 100 (FIG. 1) to produce sparse periodic illumination emitted from an illuminated sample 108 and a processor 111 that receives and phase-shifts each sparse periodic illumination image at three or more different phase shift angles to produce the diffraction-limited line-confocal image 304. Once a plurality of diffraction-limited confocal images 304 are generated of a particular sample 108 or image-type by the line-scanning confocal microscopy system 100, the processor 111 combines these or more diffraction-limited confocal images 304 to produce a respective one-dimensional super-resolved image 306 of that diffraction-limited line-confocal image 304 stored in a database 116 in operative communication with the processor 111.

In one aspect, processor 111 stores a plurality of matched data training pairs 301 in the database 116 with each matched data training pair 301 consisting of a diffraction-limited line-confocal image 304 of a sample or image-type and a corresponding one-dimensional super-resolved image 306 of that same sample or image type produced from combining the diffraction-limited confocal images 304 together of the sample or image-type. For example, the database 116 may store a plurality of matched data training pairs 300 of a certain kind of sample with each training pair 300 consisting of a diffraction-limited line-confocal image 304 of the sample or image-type and the corresponding one-dimensional super-resolved image 306 of the sample or image-type of that same diffraction-limited line-confocal image 304.

As shown in FIGS. 1 and 2A-2C, an embodiment of a line-scanning confocal microscopy system 100 for producing diffraction-limited line-confocal images 304 and matched with one-dimensional super-resolved images 306 is illustrated. As shown in FIG. 1, the line-confocal microscopy system 100 produces a line-scanned confocal image 115 of a sample 108 that is phase-shifted and shuttered to produce a phi₁ image 116A at a first phase shift, a phi₂ image 116B at a second phase shift, and phi₃ image 116C at a third phase shift by a processor 111, which combines and processes these phase-shifted images 116A-116C to produce a one-dimensional super-resolved image 306. In one arrangement, the line-scanning confocal microscopy system 100 includes an illumination source 101 that transmits a laser beam 112 through, for example a fast shutter 102, and then through a sharp illumination generator and scanner 103 that produces a shuttered sharp illumination line scan 113. The shuttered sharp illumination line scan 113 then passes through a relay lens system comprising first and second relay lenses 104 and 105 before being redirected by a dichroic mirror 106 through an objective 107 for focusing the shuttered illumination line scan 113 through a sample 108 for illuminating and scanning the sample 108. In some embodiments, the fast shutter 102 (e.g., acousto-optic tunable filter—AOTF) in communication with the illumination source 101 is operable for blanking the laser beam 112 generated by the illumination source 101 through a line illuminator, such as sharp illumination generator and scanning mechanism 103, which generates the shuttered illumination line scan 113. Alternatively, a spatial light modulator (not shown) may be used to blank the laser beam 112 for generating the shuttered illumination line scan 113. In some embodiments, the dichroic mirror 106 redirects and images the shuttered illumination line scan 113 to the back focal plane of an objective 107 that illuminates the sample 108 with a sparse structured illumination pattern. Once the sample 108 is so illuminated, fluorescence emissions 114 emitted by the sample 108 at a particular orientation relative to the plane of the sample 108 are collected epi-mode through the objective 107 and separated from the shuttered illumination line scan 113 via dichroic mirror 106 prior to being collected by a detector 110, for example a camera, after passing through a tube lens 109 in 4f configuration in communication with the objective 107. If a spatial light modulator is used, the spatial light modulator is imaged to the sample 108 by the first and second relay lenses 104 and 105 without using the dichroic mirror 106. In some embodiments, a filter (not shown) may be placed prior to the detector 110 which functions to reject laser light.

As shown, a processor 111 is in operative communication with the detector 110 for receiving data related to the fluorescence 114 emitted by the sample 108 after being illuminated by the shuttered illumination line scan 113. In some embodiments, the sample 108 may be illuminated and the resultant fluorescence obtained at different phases with each diffraction-limited line-confocal image of the sample 108 imaged at a respective different phase.

In one aspect, each of the diffraction-limited line-confocal images may be inputted into a trained neural network 302A for evaluation to generate a respective one-dimensional super-resolved image and then combining a plurality of one-dimensional super-resolved images 308 of the sample 108 at various angles using a joint deconvolution technique to produce an isotropic, super-resolved image 310.

Referring to FIG. 2A, a diffraction-limited confocal image 115 is shown illustrating the shuttered illumination line scan 113 scanned horizontally from left to right that results in an optically-sectioned diffraction-limited line-confocal image generated by microscopy system 100. As noted above, the fast shutter 102 blanks the laser beam 112 such that the shuttered illumination line scan 113 is scanned from left to right relative to the sample 108 such that sparse periodic illumination patterns are produced. For example, as shown in FIG. 2B each of the sparse periodic illumination patterns 116A, 116B, and 116C (denoted by phi₁, phi₂, and phi₃) generated by the shuttered illumination line scan 113 was phase shifted about 120 degrees relative to each other, although in other embodiments, any plurality of phase shifts may be applied to the sparse periodic illumination patterns generated by the microscopy system 100. Once phase shifted, each of the sparse periodic illumination patterns 116A, 116B and 116C are combined together to produce a one-dimensional super-resolved image 306 that has about a two-fold increase over the diffraction-limited line-confocal image 304 in spatial resolution in the direction of the line scan (e.g. one spatial dimension) as shown in FIG. 2C.

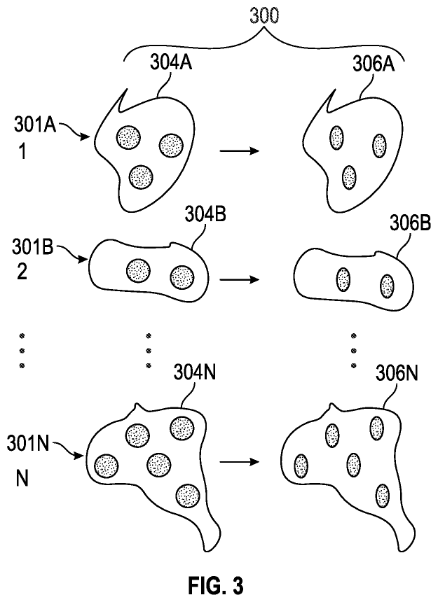

As noted above and shown in FIG. 3, a training data set 300 comprises a plurality of matched data training pairs 301A-301N with each matched data training pair 301 consisting of a diffraction-limited line confocal image 304 of a sample or image-type and a corresponding one-dimensional super-resolved image 306 of that diffraction-limited confocal image 304 of the sample or image-type using the phase shifting method discussed above. The fact that the underlying sample or image-type displays no preferred orientation implies that a sufficient range of randomly oriented samples or image-types can be easily sampled such that a sufficient number of matched data training pairs 301 can be obtained.

For example, as illustrated in FIG. 3, a training data pair 301A consists of diffraction-limited confocal image 304A and its corresponding one-dimensional super-resolved image 306A of a sample or image-type at a first orientation, while matched data training pair 301B consists of a diffraction-limited line-confocal image 304B of a different sample or image-type at a second orientation and its corresponding one-dimensional super-resolved image 306B. This process is repeated N number of times until the sample or image-type is scanned at different orientations to obtain the requisite number of matched data training pairs 301N. As shown, N samples (e.g., images of cells) with fluorescently labeled structures (gray) are imaged to obtain diffraction-limited line-confocal images 304A, 304B, which are processed as illustrated in FIGS. 2A-2C to produce corresponding one-dimensional super-resolved images 306A, 306B, etc. of those images 304A, 304B, etc., that generate respective training data pairs 301A, 301B, etc. As noted above, the diffraction limited confocal images 304 are obtained with the line-confocal microscopy system 100 by line scanning in the horizontal direction. Alternatively, post-processing a series of images with sparse line illumination structure as in FIG. 3 result in the images along the right column of FIG. 3, with resolution enhancement along the horizontal direction.

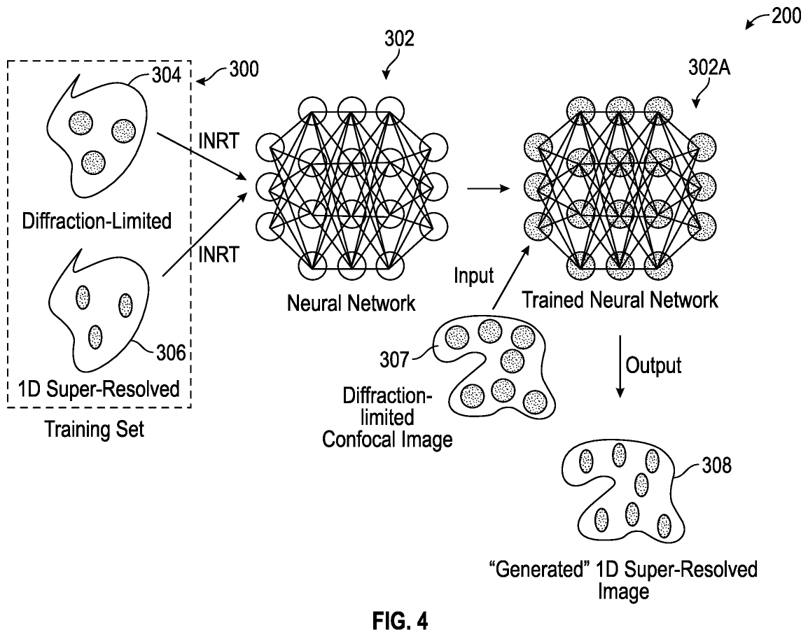

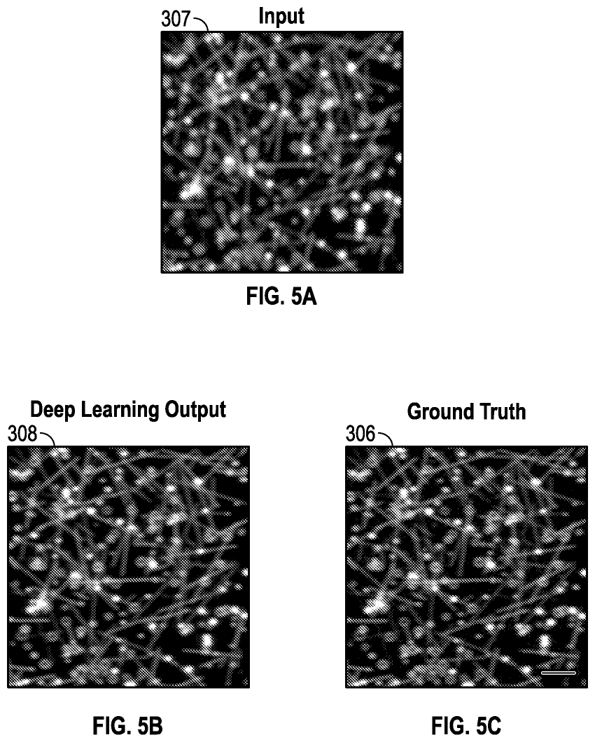

Referring to FIG. 4, once a sufficient number matched data training pairs 301 are produced for a particular kind of sample or image-type, the training data set 300 of matched data training pairs 301 is used to train a neural network 302, for example, U-Net or ROAN, employing method 200 to “predict” a one-dimensional super-resolved image 308 constructed based solely on the evaluation of a diffraction-limited line-confocal image input 307 that has never been previously evaluated by the neural network 302, but is similar to the kind of sample or image-type that the neural network 302 was trained on. As shown in FIG. 5B, the trained neural network 302A can produce highly accurate rendering of a one-dimensional super-resolved image 308 based solely on evaluating the diffraction-limited line-confocal image input 307 into the trained neural network 302A.

Referring to FIGS. 5A-5C, testing of a trained neural network 302A was conducted using simulated data. A blurred image of simulated data comprising mixed structures of dots, lines, rings and solid circles of a diffraction-limited line-confocal image input 307 (FIG. 5A) was entered into the trained neural network 302A which generated a one-dimensional super-resolved image 308 output (FIG. 5B) having the spatial resolution equivalent to a ground truth (FIG. 5C) of a one-dimensional super-resolved image. A comparison of the deep learning output of the trained neural network 302A with the ground truth output using simulated data shows that the deep learning output 308 generated by the trained neural network 302A is a highly accurate rendering, closely resembling the actual one-dimensional super-resolved image 306 of the ground truth.

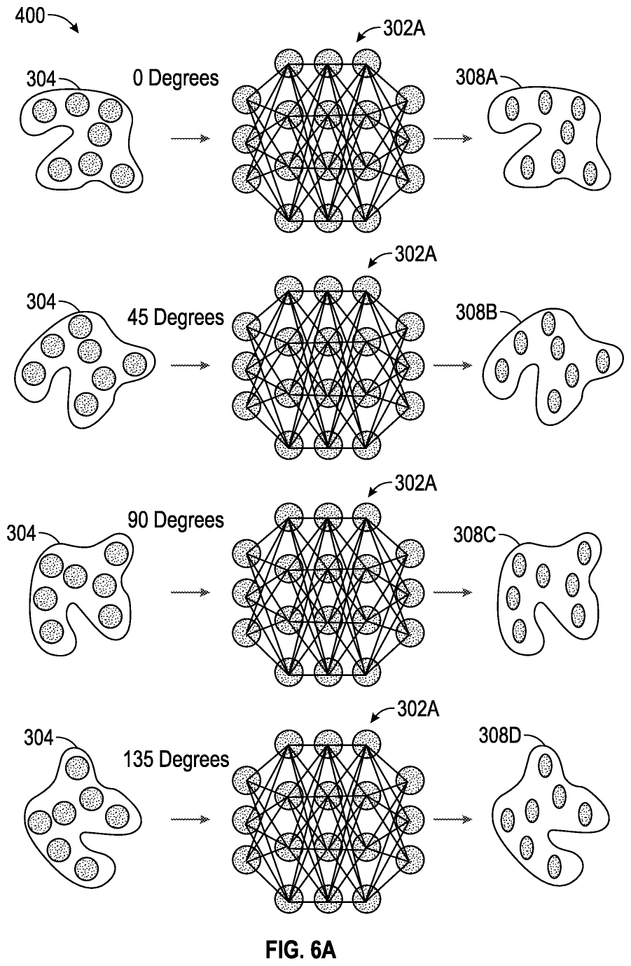

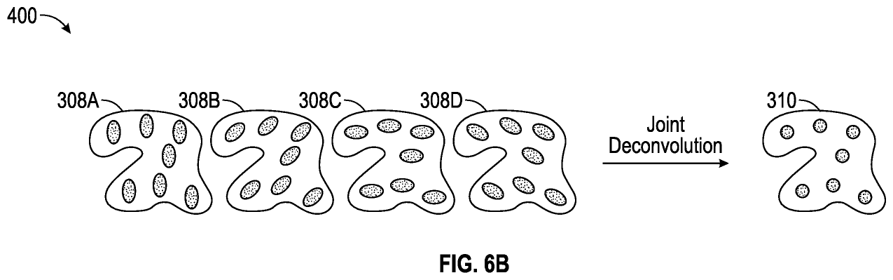

Referring to FIGS. 6A and 6B, in another aspect of the inventive concept illustrated as method 400, a diffraction-limited line-confocal image 304 of a sample or image-type obtained from microscopy system 100 can be rotated along different orientations (e.g., 0 degrees, 45 degrees, 90 degrees, and 135 degrees) to produce a series of generated one-dimensional super-resolved images 308A-308D oriented at those specific orientations by the trained neural network 302A. As shown in FIG. 6B, these one-dimensional super-resolved images 308A-308D at different orientations generated by the trained neural network 302A can be rotated back into a frame of the original one-dimensional super-resolved image 308 oriented at 0 degrees, combined using a joint deconvolution operation (e.g., with the Richardson-Lucy algorithm) that yields an isotropic super-resolved image 310 with the best spatial resolution along each orientation. In one aspect, entering at least two diffraction-limited line-confocal images 304 at different orientations into the trained neural network 302A produces an isotropic super-resolved image 310 having enhanced spatial resolution along those orientations when later combined using the joint deconvolution operation.

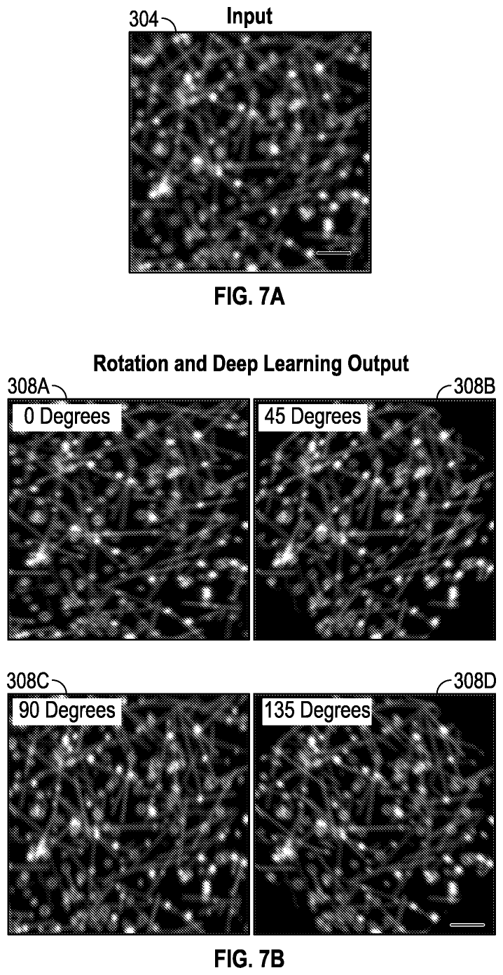

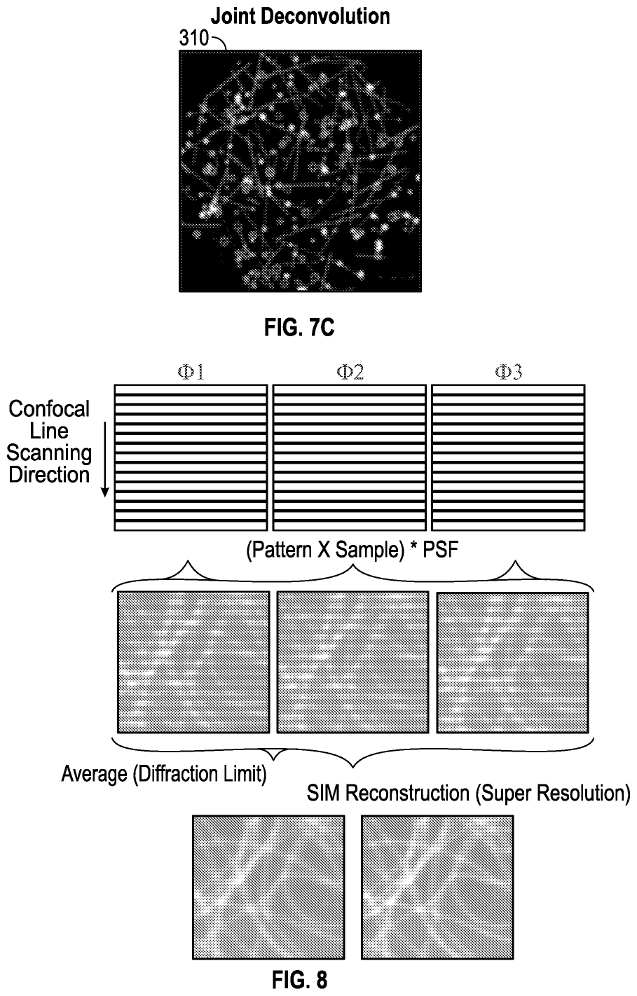

FIGS. 7A-7C show an example of this isotropic resolution recovery by combining a series of deep learning outputs (e.g., generated one-dimensional super-resolved images 308 based on the corresponding diffraction-limited line-confocal images 304 at different orientations) having one-dimensional spatial resolution enhancement along different orientations or axes. FIG. 7A is a raw input image simulated with a mixture of dots, lines, rings, and solid circles, blurred with a diffraction-limited point spread function (PSF), and degraded by adding Poisson and Gaussian noise to the image. FIG. 7B shows four generated one-dimensional super-resolved images 308A-308D oriented at 0 degrees, 45 degrees, 90 degrees, and 135 degrees, respectively, after performing the method steps shown in FIG. 6A. A deconvolution operation of these one-dimensional super-resolved images 308A-308D, as shown in FIG. 6B, results in an isotropic, two-dimensional super-resolved image 310 as shown in FIG. 7C. It was found that after the neural network 302A is trained, one-dimensional super-resolved images 308 may be generated by the trained neural network 302A without any loss of speed or increase in dose relative to the base diffraction-limited line-confocal images 304.

Referring to FIG. 8, a test using real data was conducted to prove the efficacy of the present method for training a neural network 302 to predict and generate a one-dimensional super-resolved image 308 based on a de novo evaluation of a diffraction-limited confocal image input 307 entered into the trained neural network 302A. Specifically, the top row of FIG. 8 shows the illumination patterns of a confocal line scan at phase shifts phi₁, phi₂, and phi₃, while the middle row shows the real fluorescence images of cells with microtubule markers, and how the phi₁, phi₂, and phi₃ images appear in those real fluorescence images. Finally, the bottom row shows the diffraction-limited line-confocal image (left-bottom row of FIG. 8) and the corresponding one-dimensional super-resolved image 306 in which a local contraction operation was applied (right-bottom row of FIG. 8) that results in resolution improvement along one-dimension, in this instance the “y” direction along which the line-scan was scanned.

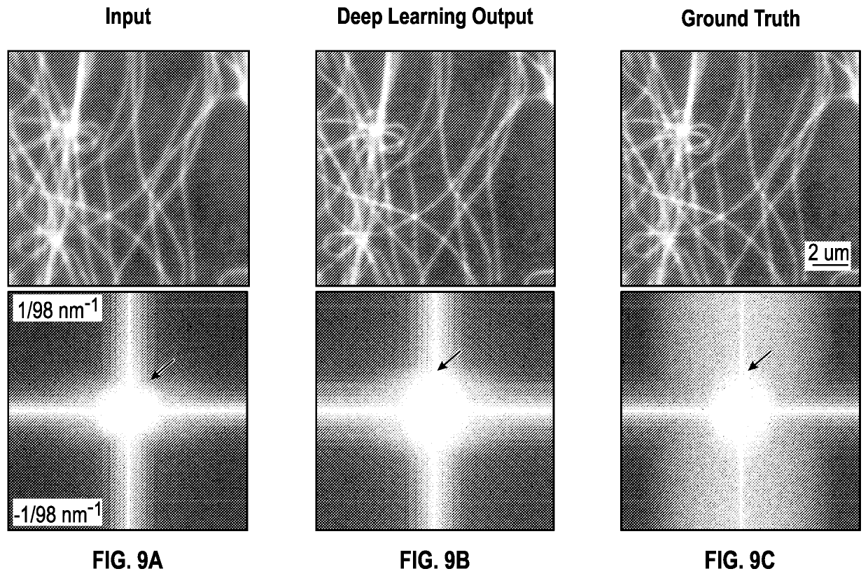

FIGS. 9A-9C are images of a test using real data similar to the tests illustrated in FIGS. 7A-7C. As shown, the top row of FIGS. 9A-9C each show an microtubule fluorescence image 304 taken in diffraction-limited mode (FIG. 9A), the deep learning output (FIG. 9B) of a one-dimensional super-resolved image 308 of the microtubule fluorescence diffraction-limited line-confocal image 304 by the trained neural network 302A based on the evaluation of the microtubule fluorescence image 304 taken in diffraction-limited mode (FIG. 9A), and the ground truth (FIG. 9C) that shows a one-dimensional super-resolved image that was enhanced using a local contraction operation. The bottom row of FIG. 9A is the Fourier transform of the diffraction-limited confocal input to the trained neural network 302A prior to being evaluated by the trained neural network 302A. Similarly, the bottom rows of FIG. 9B and FIG. 9C show the corresponding Fourier transforms of the images generated in the corresponding top rows, which indicate improvement in one-dimensional (e.g., vertical) resolution, respectively.

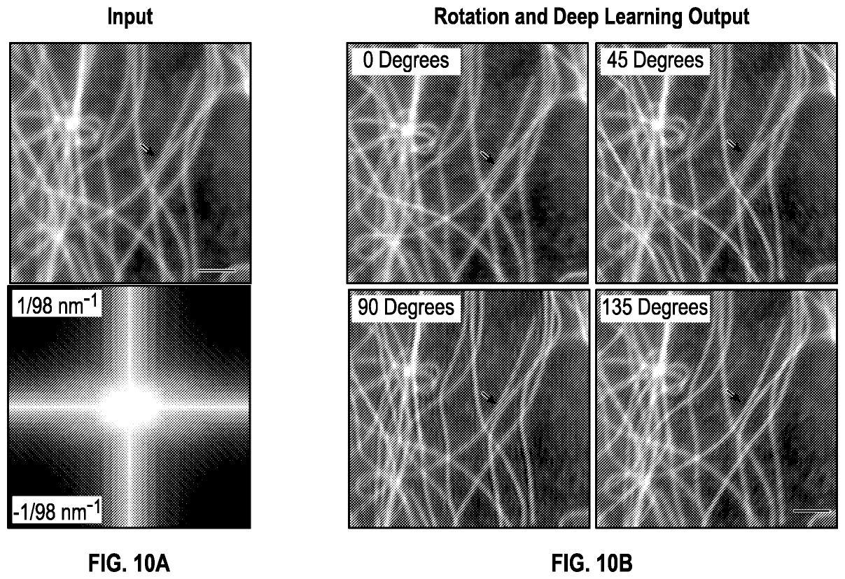

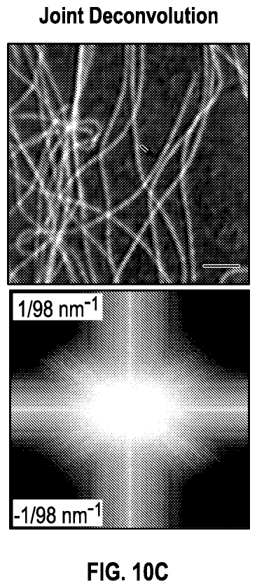

FIGS. 10A-10C are images of a test using real data similar to the tests illustrated in FIGS. 7A-7C in which simulated data was used rather than real data. The top row of FIG. 10A is the diffraction-limited image input, while FIG. 10B is the generated one-dimensional super-resolved image 308 output of the trained neural network 302A after the input image 10A has been rotated along four different orientations—0 degrees, 45 degrees, 90 degrees, and 135 degrees, respectively, while the top row of FIG. 10C is the isotropic two-dimensional super-resolved image 310 produced using a joint deconvolution operation. The bottom rows of FIGS. 10A and 10C show Fourier transforms in which the Fourier transform of FIG. 10B indicates that the better resolution of the image shown at the top row of FIG. 10C than the diffraction-limited image shown at the top row of FIG. 10A.

In one aspect, the image-type may be of the same type of sample (e.g. cells) that emits a fluorescent emissions when illuminated by a line-confocal microscopy 100.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for improving spatial resolution comprising:
producing a plurality of diffraction-limited line-confocal images of an image-type and producing a plurality of one-dimensional super-resolved images of the image-type corresponding to the plurality of diffraction-limited line-confocal images of the image-type;
generating a training set comprising a plurality of matched training pairs, each training pair of the plurality of training pairs comprising a diffraction-limited line-confocal image of the plurality of diffraction-limited line-confocal images of the image-type and a one-dimensional super-resolved image corresponding to the diffraction-limited line-confocal image of the plurality of diffraction-limited line-confocal images; and
training a neural network by entering as input the plurality of matched training pairs of the image-type; and
generating a one-dimensional super-resolved image of the image-type by the neural network based an evaluation of a diffraction-limited line-confocal image input into the neural network.

2. The method of claim 1, wherein the neural network evaluates the diffraction-limited line-confocal image of the image-type by identifying similarities between the diffraction-limited line-confocal image input of the image-type entered into the neural network and the plurality of diffraction-limited line-confocal images of the image-type in the training set.

3. The method of claim 2, wherein generating the one-dimensional super-resolved image of the image-type by the trained neural network is based on the identification of any similarities established between the diffraction-limited line-confocal image input of the image-type evaluated by the trained neural network and the plurality of diffraction-limited line-confocal images of the training set.

4. The method of claim 3, wherein generating the one-dimensional super-resolved image of the image type by the trained neural network further comprises identifying one or more features of the corresponding one-dimensional super-resolved image of the image-type with the similarities identified between the diffraction-limited line-confocal image input and the plurality of diffraction-limited line-confocal images of the image-type from each training pair.

5. The method of claim 1, wherein each diffraction-limited line-confocal image of the plurality of diffraction-limited line-confocal images is phase-shifted and then the phase-shifted diffraction-limited line-confocal images are combined to produce a respective one-dimensional super-resolved image of the plurality of one-dimensional super-resolved images of the image-type for each matched training pair.

6. A method for producing an isotropic super-resolved image comprising:
providing a first diffraction-limited line-confocal image of an image-type at a first orientation and a second diffraction-limited line-confocal image of the image-type at a second orientation as input to a neural network;
generating as output from the neural network a first one-dimensional super-resolved image of the first diffraction-limited line-confocal image of the image-type at the first orientation and a second one-dimensional super-resolved image of the image-type at the second orientation; and
combining, by a processor, the first one-dimensional super-resolved image of the image-type at the first orientation and the second one-dimensional super-resolved image of the image-type at the second orientation to produce an isotropic, super-resolved image as output by the processor.

7. The method of claim 6, wherein the processor combines the first one-dimensional super-resolved image of the image-type at the first orientation and the second one-dimensional super-resolved image of the image-type at the second orientation using a joint deconvolution operation to produce the isotropic super-resolved image.

8. The method of claim 7, wherein the processor uses a Richardson-Lucy algorithm to perform the joint deconvolution operation.

9. The method of claim 6, wherein the first orientation is a different orientation than the second orientation.

10. The method of claim 6, further comprising:
providing a third diffraction-limited line-confocal image of an image-type at a third orientation as input to the neural network;
generating as output from the neural network a third one-dimensional super-resolved image of the first diffraction-limited line-confocal image of the image-type at the third orientation; and
combining, by a processor, the third one-dimensional super-resolved image of the image-type at the third orientation with the second one-dimensional super-resolved image of the image-type at the second orientation and the first one-dimensional super-resolved image at the first orientation to produce the isotropic, super-resolved image as output by the processor.

11. The method of claim 10, further comprising:
providing a fourth diffraction-limited line-confocal image of an image-type at a fourth orientation as input to the neural network;
generating as output from the neural network a fourth one-dimensional super-resolved image of the first diffraction-limited line-confocal image of the image-type at the fourth orientation; and
combining, by a processor, the fourth one-dimensional super-resolved image of the image-type at the fourth orientation with the third one-dimensional super-resolved image of the image-type at the third orientation, the second one-dimensional super-resolved image of the image-type at the second orientation, and the first one-dimensional super-resolved image at the first orientation to produce the isotropic, super-resolved image as output by the processor.
